(19) United States
(12) Patent Application Publication
(10) Pub. No.: US 2026/0044590 A1
(43) Pub. Date: Feb. 12, 2026

(54) SYSTEMS AND METHODS FOR DEVICE AUTHENTICATION VERIFICATION VIA ELECTRONIC COMMUNICATION

(71) Applicant: BANK OF AMERICA CORPORATION, CHARLOTTE, NC (US)

(72) Inventors: Subramanian Kathiresan, Harrisburg, NC (US); Navdeep Mahajan, Charlotte, NC (US); Arunachalam Packirisamy, Pleasant Hill, CA (US); Pavan K. Chayanam, Alamo, CA (US); Prashanth Kolar, Dublin, CA (US); Sandhya Karanam, Dublin, CA (US)

(73) Assignee: BANK OF AMERICA CORPORATION, CHARLOTTE, NC (US)

(21) Appl. No.: 18/798,276

(22) Filed: Aug. 8, 2024

(51) Int. Cl. G06F 21/44; H04L 9/32; H04L 9/40

(52) U.S. Cl. CPC G06F 21/44; H04L 9/3226; H04L 63/10

(57) ABSTRACT

Systems, computer program products, and methods are described herein for device authentication verification via electronic communication. The present disclosure is configured to receive an interaction from a resource container, wherein the interaction is associated with an application. Further, the present disclosure is configured to transmit a token from an authorization hub to a user device. Further still, the present disclosure is configured to receive user data from the resource container associated with a user, wherein the user data is received via a near field communication (NFC) device embedded in the resource container, and wherein the NFC device emits NFC signals. Further still, the present disclosure is configured to encrypt the user data using the token. Further still, the present disclosure is configured to validate the user data using the authorization hub. Further still, the present disclosure is configured to store the user device as a verified user device.

### TECHNOLOGICAL FIELD

Example embodiments of the present disclosure relate to device authentication via electronic communication.

### BACKGROUND

There are significant challenges associated with authentication of devices. Applicant has identified a number of deficiencies and problems associated with conventional device verification techniques. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for device authentication verification via electronic communication.

Embodiments of the present invention address the above needs and/or achieve other advantages by providing apparatuses (e.g., a system, computer program product, and/or other devices) and methods for device authentication verification via electronic communication. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives an interaction from a resource container, wherein the interaction is associated with an application. In some embodiments, the present invention transmits a token from an authorization hub to a user device. In some embodiments, the present invention receives user data from the resource container associated with a user, wherein the user data is receive via a near field communication (NFC) device embedded in the resource container, and wherein the NFC device emits NFC signals. In some embodiments, the present invention encrypts the user data using the token. In some embodiments, the present invention validates the user data using the authorization hub. In some embodiments, the present invention stores the user device as a verified user device.

In some embodiments, the authorization hub is configured to manage access control policies, wherein the access control policies define user access permissions. In some embodiments, the authorization hub is configured to authenticate the user data, wherein authenticating the user data includes validating the user data associated with the NFC signals. In some embodiments, the authorization hub is configured to authorize the interaction, wherein authorizing the interaction includes comparing the user data with the access control policies to determine an access level associated with the user device.

In some embodiments, the present invention receives the NFC signals emitted from the NFC device. In some embodiments, the present invention generates a user prompt, wherein the user prompt requests the user to enter a user input via the user device. In some embodiments, the present invention receives the user input, wherein the user input includes a personal identification number (PIN) associated with the user. In some embodiments, the present invention validates the user input using the authorization hub.

In some embodiments, the interaction further includes a resource transaction, wherein the resource transaction exceeds a threshold value.

In some embodiments, encrypting the user data using the token further includes requesting, via the application, the token from the authorization hub. In some embodiments, encrypting the user data using the token further includes generating, via the authorization hub, the token, wherein the token may be configured to encrypt the user data. In some embodiments, encrypting the user data using the token further includes transmitting the token from the authorization hub to the application. In some embodiments, encrypting the user data using the token further includes encrypting the user data using the token generated by the authorization hub.

In some embodiments, storing the user device as the verified user device further includes bypassing verification of future interactions associated with the user device.

In some embodiments, validating the user data further includes determining the user data received from the resource container matches a user database, wherein the user database includes information associated with the user.

In some embodiments, the present invention receives a new interaction from a new resource container, wherein the new resource container is associated with the user, and wherein the new interaction is received via NFC signals. In some embodiments, the present invention validates the new resource container via the verified user device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for device authentication verification via electronic communication, in accordance with an embodiment of the disclosure;

FIG. 2 illustrates a process flow for device authentication verification via electronic communication, in accordance with an embodiment of the disclosure;

FIG. 3 illustrates an example embodiment of the interactions associated with the device authentication verification system, in accordance with an embodiment of the disclosure;

FIG. 4 illustrates an example of a multifactor authentication procedure associated with the device authentication verification system, in accordance with an embodiment of the disclosure; and

FIG. 5 illustrates a process flow of the operations of a user device, an application, and an authorization hub associated with the device authentication verification system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” and “resource container” may refer to an electronic payment vehicle, such as an electronic credit or debit card. The payment instrument or resource container may not be a “card” at all and may instead be account identifying information stored electronically in a user device, such as payment credentials or tokens/aliases associated with a digital wallet, or account identifiers stored by a mobile application. Further, in some embodiments, the payment instrument or resource container may include near-field communication (NFC) technology. In this way, NFC may include short range communications, wireless communications, and two-way communications to transfer data between devices. Devices that have NFC capabilities may include a tag, chip, embedded component, signal transmitter, communication producer, or the like that may read and/or write information from one device to another. The NFC tag may be passive, meaning the tag is unpowered and may store information onto the chip. The information on the NFC may be edited, updated, deleted, or the like, either by a dedicated device, or by another device with NFC capabilities. Some NFC tags may require security clearance to edit the information stored on the tag, however.

Further, NFC technology may enable an initiating device to generate a radio frequency field to which a receiving device may respond. The initiating device may send a signal to the receiving device, wherein the receiving device may modulate the signal in order to send information back, allowing for data exchange between the two devices. Typically, NFC technology requires the initiating device to be within a close proximity to the receiving device for the radio frequency field to be registered. The short range of NFC technology allows for an additional layer of security by limiting other, perhaps malicious, signals to interfere with the communication.

The benefits of the security of NFC technology are often underutilized in the modern world. For instance, security of multifactor authentication processes can be greatly enhanced by using NFC technologies. Conventional multifactor authentication processes are typically carried out via a text message (short message service, or SMS) or similar platform. In this way, a user may attempt to carry out an interaction with a service provider, for example, and the service provider may send a text message to the user to verify their identity and interaction. However, a malicious individual may easily misappropriate the user's mobile device and receive the text message to circumvent the security systems in place. Therefore, a device authentication verification via electronic communication is introduced.

The system (e.g., system 130, as described herein) may receive an interaction (e.g., account login, payment transaction, account setup, or the like) from a user's cell phone, or the like. The system may then request a token from an authorization hub, wherein the token may be used to encrypt user data for verification purposes. The system may prompt the user, on the user device, to use NFC technology to provide the user's data to the user device. In this way, the user may tap a credit card, debit card, or the like (e.g., a resource container with NFC technology) to the user device to transfer the user data in a secure manner. The system may then verify the user data in the authorization hub and allow the user to continue with the interaction. Further, in some embodiments, the system may store the user device as a verified user device for future interactions, allowing for bypass of the verification process.

In the modern world, verification and validation is a critical part of any secure process, especially processes dealing with resource transactions. Ensuring that a user device (e.g., a mobile phone, computer, tablet, or the like) or a credit card, debit card, etc., are valid and associated with a user is important to maintaining integrity of secure and trusted operations. Without such securitization procedures, misappropriation of users'identities and belongings would become convenient and easy for malicious individuals. Further, users would not be able to trust interactions with third parties without a secure system to perform those interactions. Currently, conventional systems designed to securely authorize a user's interaction may fall short due to the uncertainties surrounding traditional methods of validating interactions. Authorization procedures using short messaging services, electronic mail, and web applications do not offer the security levels required for today's security landscape. Securing transactions using short-range communication signals offer high levels of security to protect users against malicious individuals looking to misappropriate the user's identity, resources, finances, and the like. Therefore, systems and methods for device authentication verification via electronic communication are introduced.

The present disclosure provides a system for securely authorizing a user's interaction. A user may need to authenticate an interaction the user has initiated, such as an account login attempt, a transaction, a new credit or debit card activation, or the like. The system may receive such an interaction via a point of sale (POS) device associated with a merchant, for example. In this way, the user may a debit card during a transaction with the POS device. The POS device may include an application that communicates with an authorization hub, hosted by an entity associated with the device authentication system (e.g., system 130 as described herein). The application may request a token be generated by the authorization hub and sent to the user's device (e.g., mobile phone). The user's mobile phone may request the user tap the user's debit card to the user device, utilizing the debit card's NFC capabilities to transmit user data. The user's mobile phone may prompt the user to enter the personal identification number (PIN) associated with the debit card. Upon the correct PIN entry, the user data may be encrypted via the token and securely transmitted to the authorization hub. The authorization hub may then validate the user data and allow the transaction to continue.

What is more, the present disclosure provides a technical solution to a technical problem. As described herein, the technical problem includes securely validating a user interaction. The technical solution presented herein allows for effective securitization of user interactions using NFC signals and validation of user data via an authorization hub. In particular, device authentication system (e.g., the system 130 as described herein) is an improvement over existing solutions to the issues surrounding conventional methods for validating user interactions, (i) with fewer steps to achieve the solution, thus reducing the amount of computing resources, such as processing resources, storage resources, network resources, and/or the like, that are being used (e.g., by trusting validated devices upon successful validation using the device authentication system), (ii) providing a more accurate solution to problem, thus reducing the number of resources required to remedy any errors made due to a less accurate solution (e.g., by using a user's resource container and associated NFC capabilities to securely validate a user interaction), (iii) removing manual input and waste from the implementation of the solution, thus improving speed and efficiency of the process and conserving computing resources (e.g., using an authorization hub and automating the process of validating a user's interaction), (iv) determining an optimal amount of resources that need to be used to implement the solution, thus reducing network traffic and load on existing computing resources (e.g., by recording and storing verified and validated devices in the system for future interactions). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the device authentication system (e.g., the system 130) as described herein is a solution to the problem of verification and authentication issues associated with conventional procedures for verifying user interactions, devices, and the like. Further, the device authentication system may be characterized as identifying a specific improvement in computer capabilities and/or network functionalities in response to the device authentication system's integration to existing devices, software, applications, and/or the like. In this way, the device authentication system improves the capability of a system to efficiently and effectively authenticate and verify user interactions using NFC signals. Further, the device authentication system improves the functionality of networks in response to reducing the resources consumed by the system (e.g., network resources, computing resources, memory resources, and/or the like).

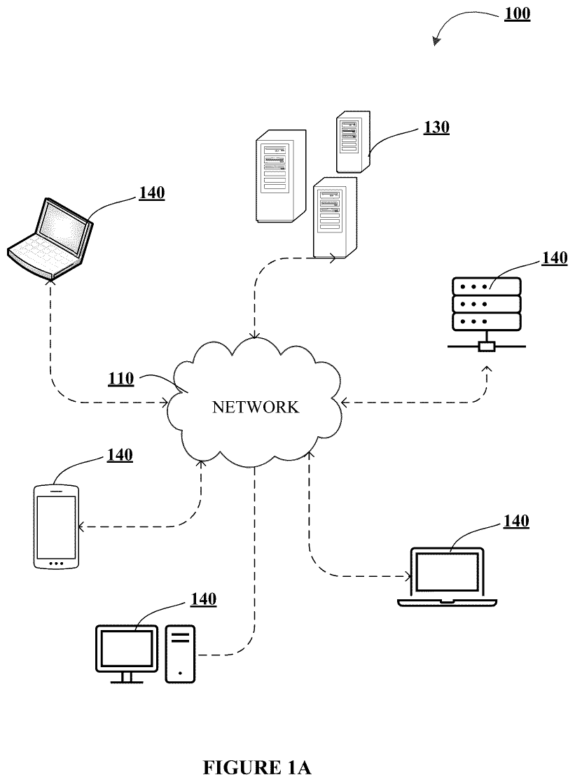

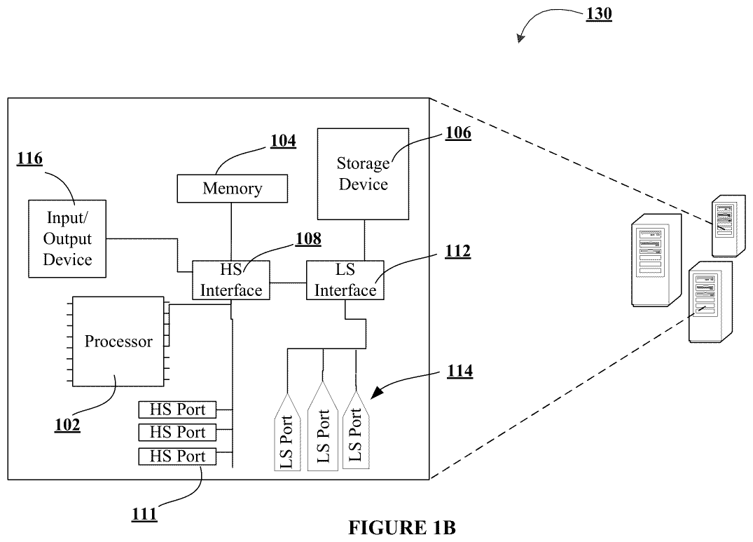

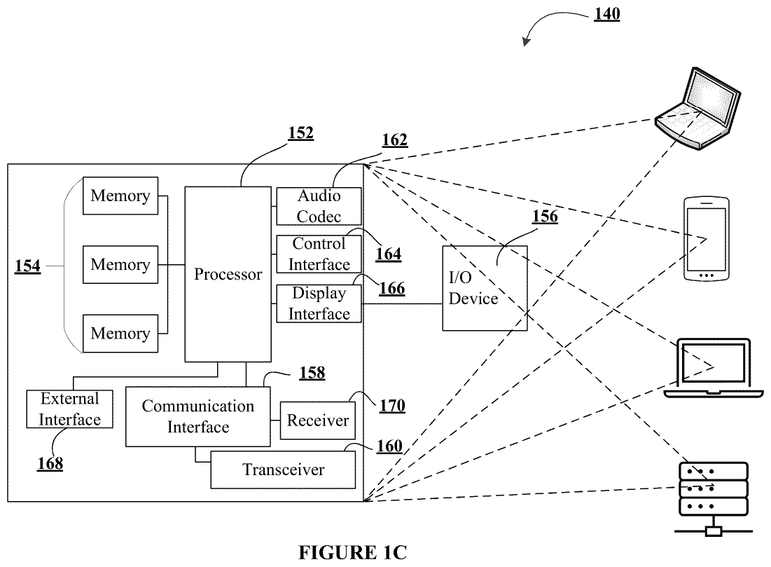

FIGS. 1A-1C illustrate technical components of an exemplary distributed computing environment 100 for device authentication verification via electronic communication, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

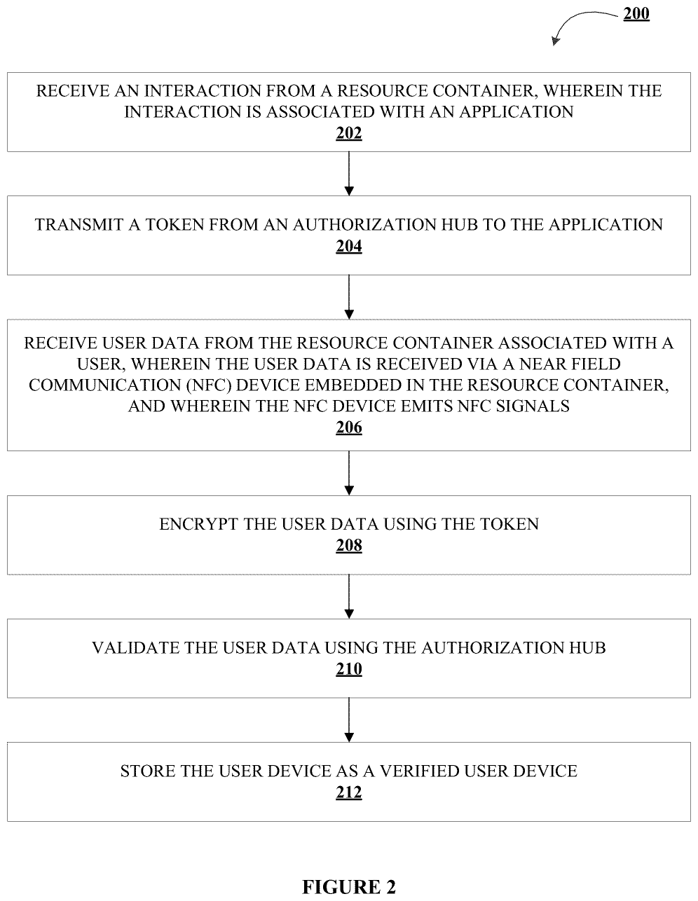

FIG. 2 illustrates a process flow for device authentication verification via electronic communication, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a device authentication system (e.g., similar to one or more of the systems described herein with respect to FIGS. 1A-1C) may perform one or more of the steps of process flow 200. For example, a device authentication system (e.g., the system 130 described herein with respect to FIGS. 1A-1C) may perform the steps of process flow 200.

As shown in block 202 of FIG. 2, the process flow 200 of this embodiment includes receiving an interaction from a resource container, wherein the interaction is associated with an application. In some embodiments, the resource container may include a credit card, debit card, card issued by a financial institution, or the like. In some embodiments, the resource container may include components similar to the end-point device 140 as described in FIG. 1C. The components, such as a processor (e.g., the processor 152), memory (e.g., the memory 154), communication interface (e.g., the communication interface 158), I/O device (e.g., I/O device 156), and the like may be included in the resource container.

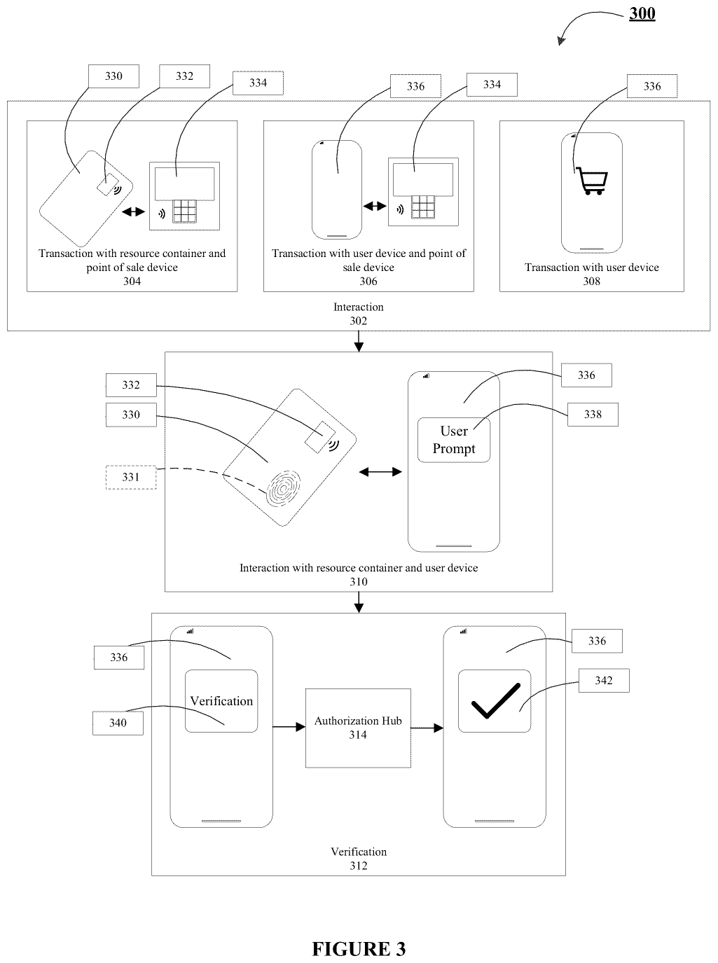

In some embodiments, the interaction may include a transaction of resources, wherein the user is transacting resources for goods, services, transfer of resources, loans, or the like. For example, as shown in FIG. 3, the interaction 302 may take many forms. The types of interactions include, but are not limited to, a transaction with the resource container and a point-of-sale (POS) device 304, a transaction with a user device and a POS device 306, and a transaction with the user device 308. In the transaction with a resource container and a POS device 304 example, a user may use the resource container 330 to transact with a POS device 334. The resource container 330 may include a near field communication (NFC) device 332. In this way, the resource container 330 may be close in proximity to the POS device 334 to perform the transaction via the NFC device and NFC signals.

Further, in the transaction with a user device and a POS device 306, the user device 336 may be used to complete a transaction with a POS device 334. For example, the user device 336 may be equipped with an NFC device to initiate the transaction. In this example, the user device 336 may emit NFC signals via the NFC device, which may be read by a NFC device in the POS device 334. Further, in other embodiments, the user device 336 may use other non-NFC methods to initiate the transaction and communication with the POS device 334. For instance, the user device 336 may use network communications, wireless signals, wired signals, or other communication methods to carry out a transaction with the POS device 334.

In addition, and in some embodiments, the transaction with a user device 308 may include a transaction solely on the user device 336. In this way, the user device 336 may be used to transact through the internet, network, intranet, or other communication network to initiate and carry out a transaction. For instance, the user device 336 may connect with a merchant, service, kiosk, terminal, server, computer, or the like to perform an interaction 302.

In some embodiments, the application may be the application to receive the interaction. In some embodiments, the application may be associated with a user device, a POS device, a kiosk, a merchant terminal, an online platform, or the like. In this way, the application may be configured to receive a transaction initiation from a resource container, a user device, or the like.

As shown in block 204 of FIG. 2, the process flow 200 of this embodiment includes transmitting a token from an authorization hub to the application. In some embodiments, the authorization hub may generate the token. The token generation may be generated and issued (e.g., transmitted) to the application, user device, or the like. The token may allow for authentication and authorization of the user device via transmitting user data, user permissions, and the like to the authorization hub. Further, the token may be used to securely and confidentially transfer the user data to the authorization hub. In addition, the token may be customized to allow for additional securitization through via token expiration, token revocation, securely storing the token, and the like.

Further, in some embodiments, the resource container and the user device may generate dynamic keys for each interaction. In this way, each interaction of the resource container authentication generates a unique, interaction-specific key used for encrypting the communication, making every authentication session unique and secure. In some embodiments, a key agreement protocol may be implemented. The user device and the resource container may generate their own temporary private and public keys. The public keys may be exchanged via the NFC signals, after which both the resource container and the user device compute an identical session key independently. The session key may be used to encrypt and decrypt the data transmitted (e.g., via the NFC signals) during that session. In this way, the dynamic nature of the key generation makes any data maliciously intercepted from a session unable to be reused.

In some embodiments, the authorization hub may manage access control policies which define user access permissions. The access control policies associated with the authorization hub may indicate how the user is allowed to navigate through the interaction. In this way, the user may be allowed to proceed with the interaction if the policies allow for the user to do so. The user access permissions may set limits on the interaction, as well, by restricting or otherwise limiting the ability for the user, via the user device, to proceed with the transaction. For instance, if user access permissions are set to limit the number of resources transferred in a resource transaction (e.g., interaction), and the present interaction is for an amount of resources above that number, the authorization hub may not allow the interaction to proceed.

Further, in some embodiments, the interaction may include a resource transaction that exceeds a threshold value. The threshold value may be a number of resources that requires the system (e.g., system 130) to verify and authenticate the interaction. The threshold value may be a standard amount of resources set by the entity or an amount of resources set by the user. For example, the user may have set the threshold amount to a limit of two thousand dollars. In this example, if a transaction is for more than two thousand dollars, the system may require verification and authorization of the transaction. The system may then require the resource container to transmit, via the NFC device, user data in order for it to be verified at the authorization hub, as described in greater detail below.

As shown in block 206 of FIG. 2, the process flow 200 of this embodiment includes receiving user data from the resource container associated with a user, wherein the user data is received via a near field communication (NFC) device embedded in the resource container, and wherein the NFC device emits NFC signals. In some embodiments, the user may be required to authenticate the NFC device prior to the NFC device emitting the NFC signals. In this way, the user may authenticate the resource container to emit the NFC signals via authentication on the resource container, itself. For example, if the resource container is a debit card, the debit card may have its own sensor or authentication procedure prior to it emitting NFC signals. As shown in FIG. 3, the resource container 330 may include an authentication sensor 331. The authentication sensor 331 may include a sensor designed to authenticate the user's identity via a variety of procedures, wherein one such procedure is scanning the user's fingerprint to identify the user. In some embodiments, the resource container may provide its own verification and authentication procedures without needing to communicate with another entity, computer system, network, or the like. In some embodiments, the resource container may include capabilities to communicate with the user device (e.g., the user device 336 in FIG. 3), the application, or the authorization hub. In this way, the resource container may confirm, with the user device, the application, or the authorization hub the identity of the user prior to the resource container emitting NFC signals.

In some embodiments, the system (e.g., system 130 as described herein) may receive the NFC signals emitted from the NFC device. The NFC device may passively or actively emit NFC signals. The NFC device may continuously emit NFC signals or may begin emitting them when triggered. The NFC signals emitted may include user data, which may include resource transaction details, routing information, identifying information, or the like that may be used during a resource transaction. Further, the NFC signals may include data that may be used for verifying and authorizing the user device or the resource container.

In some embodiments, the system may generate a user prompt and transmit the user prompt to the user device. The user prompt may request the user to enter a user input via the user input. In some embodiments, the user input may include a personal identification number (PIN) of the user. For example, as shown in FIG. 3, the interaction with the resource container and the user device 310 may include the user device 336 prompting the user with a user prompt 338. The user prompt 338 may include a request for the user to use the resource container 330 to transmit NFC signals via the NFC device 332 to the user device 336. In this way, the transmission of the NFC signals to the user device 336 may be a multifactor authentication procedure.

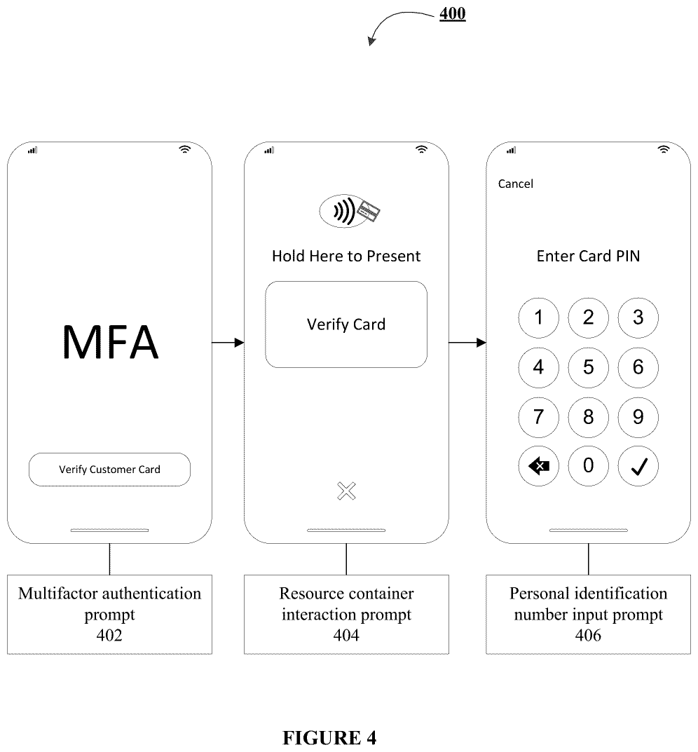

For instance, as shown in more detail in FIG. 4, the user device may show a multifactor authentication prompt 402 to the user. The user device may then prompt the user with a resource container interaction prompt 404, which may request the user to hold the resource container with a close proximity to the user device for the embedded NFC device to communicate with the user device. Additionally, or alternatively, the user device may be equipped with an NFC device of its own in order to receive the NFC signals of the resource container. Further, as shown in FIG. 4, the user device may then display a personal identification number (PIN) input prompt 406 to the user. The PIN the requested may be the PIN associated with the resource container.

In some embodiments, the system may then transmit the user data, including the PIN, to the authorization hub for validation. To do this, the system may first encrypt the user data using the token, as shown in block 208 of FIG. 2. In some embodiments, the system may encrypt the user data by requesting, via the application, the token from the authorization hub. Next, the authorization hub may generate the token used to encrypt the user data. The authorization hub may transmit the token to the application. Further, the token may be used to encrypt the user data. Encrypting the user data may include using the token or a derived key to encrypt the user data. Symmetric encryption algorithms also may be used, which may include using a secret key for encryption and decryption of the user data.

In some embodiments, and as shown in block 210 of FIG. 2, the system may validate the user data using the authorization hub. In some embodiments, the authorization hub may decrypt the user data and may verify the token's signature to ensure the user data has not been tampered with. For example, as shown in FIG. 3, the verification 312 of the user data inputted into the user device 336 may be verified via the authorization hub 314. In this way, the authorization hub may authorize the interaction, which may include comparing the user data with the access control policies to determine an access level and/or permissions of the user device.

In some embodiments, validating the user data may include determining the user data received from the resource container matches a user database. The user database may include information associated with the user. The system may compare the user data of the resource container with the user database to ensure the user's identity during validation. The user database may be stored in the authorization hub or may be accessed by the authorization hub and/or the system during validation of the user data. In this way, the comparison may be used to determine that the user is a verified user that is associated with the user device, resource container, and the like. Upon validation of the user data, the interaction may be allowed to proceed.

In some embodiments, and as shown in FIG. 3, the user device may indicate via a verification prompt 340 that the user data is being authorized at the authorization hub 314. In some embodiments, once the verification is complete, the user device 336 may indicate a successful verification prompt 342 on the user device 336.

In some embodiments, a continuous authentication protocol may be used throughout the interaction. In this way, the continuous authentication protocol may include intermittently checking the authentication credentials throughout the interaction, rather than just at login or initiation of the interaction. In some embodiments, this may include intermittently checking the dynamic keys generated by the resource container and the user device throughout the interaction. The continuous authentication protocol may include a periodic request for the resource container to transmit updated encrypted credentials at random intervals during the interaction. In some embodiments, this may be triggered by certain actions taken during the interaction (e.g., a user wishing to transfer resources, access sensitive account information, or the like). Further, the continuous authentication protocol may ensure the user who initiated the interaction is still the user in control of the interaction by providing ongoing verification to enhance security throughout the interaction.

As shown in block 212 of FIG. 2, the process flow of this embodiment includes storing the user device as a verified user device. In some embodiments, storing the user device as a verified user device may include bypassing verification of future interactions on the user device. In this way, once the user device is verified via the system (e.g., system 130), the user device may then no longer need to be verified for future transactions. In some embodiments, the user may select to require verification of the user device for every interaction or intermittently verify the user device from time to time.

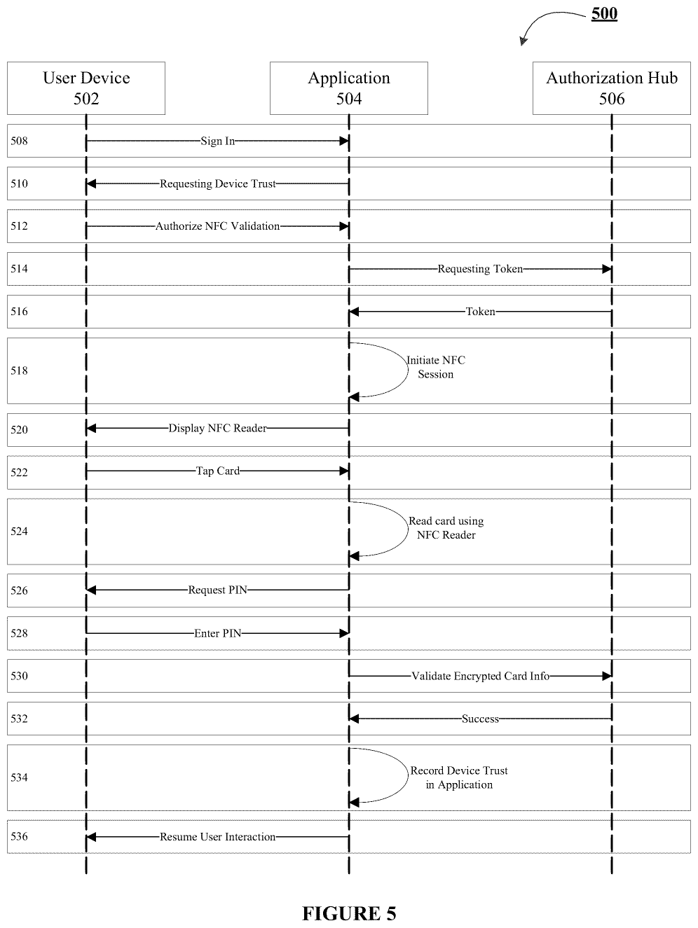

As shown in FIG. 5, an example embodiment of the present disclosure is provided. The system (e.g., system 130) may operate between a user device 502, an application 504, and an authorization hub 506. As mentioned previously, the application 504 may be installed on the user device 502. The operations of each of the user device 502, the application 504, and the authorization hub 506 may be described via FIG. 5. Initially, a user may use the user device 502 to sign in 508 to the application 504. The application 504 may be configured to request device trust 510 of the user device 502. In this way, the application 504 may determine if the user device 502 can be trusted, or if the verification process needs to be performed. In cases where the verification process needs to be performed, the user device 502 may then authorize NFC validation 512 to the application 504. The application 504 may then request a token 514 from the authorization hub 506. The authorization hub 506 may generate the token 516 and transmit the token 516 to the application 504.

Further, the application 504 may initiate the NFC session 518, wherein the application 504 requests the user device 502 to display the NFC reader 520. The user may then tap the user's card 522 to the user device 502 and the user device 502 may transfer the information to the application 504. The application 504 may read the card using the NFC reader 524. In this way, the application 504 may read information from the NFC reader on the user device 502. The application 504 may then request the user device 502 to prompt the user to enter the user's PIN 526. Once the user enters the PIN 528, the PIN may be transferred to the application 504. The application 504 may then provide the authorization hub 506 with the information and the PIN to validate the encrypted card information 530. Upon successful verification of the validation 532, the application 504 may record the device trust in the application 534. The application 504 may then proceed with the user interaction 536 on the user device 502.

In another example, the device authentication system (e.g., the system 130 as described herein) may be used to authenticate login attempts to a user's account. For example, a user may attempt to login to the user's account on a user device. The login prompt may trigger a multifactor authentication procedure. For example, this may be similar to the interaction 302 as shown in FIG. 3. The device authentication system may then generate a prompt (e.g., similar to the prompt 338 in FIG. 3) and transmit the prompt to an additional user device (e.g., similar to user device 336 in FIG. 3) with NFC capabilities. The additional user device may, in some cases, be the same user device the user performed the login attempt, or may be a different user device. For example, the user may login to the user account on a personal computer and the device authentication system may transmit the prompt to the user's mobile phone. The prompt may request the user to use the NFC device embedded in the user's resource container to authenticate the login attempt.

In yet another example, the device authentication system may be used to activate a new resource container associated with a user. In some embodiments, the system may receive the new interaction via NFC signals. In this way, the user may login to a user account on the user device to initiate activation of the new resource container. The device authentication system may then, similar to the interaction with the resource container and the user device 310 of FIG. 3, produce a user prompt on the user device requesting the user use the NFC device on the new resource container to activate the new resource container. Further, in some embodiments, the system may validate the new resource container via the verified user device. In this way, the new resource container may be presented to a previously verified user device and the system may verify and validate the new resource container.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for device authentication verification via electronic communication, the system comprising:
a processing device;
a non-transitory storage device containing instructions when executed by the processing device, causes the processing device to perform the steps of:
receive an interaction from a resource container, wherein the interaction is associated with an application;
transmit a token from an authorization hub to a user device;
receive user data from the resource container associated with a user, wherein the user data is received via a near field communication (NFC) device embedded in the resource container, and wherein the NFC device emits NFC signals;
encrypt the user data using the token;
validate the user data using the authorization hub; and
store the user device as a verified user device.

2. The system of claim 1, wherein the authorization hub is configured to:
manage access control policies, wherein the access control policies define user access permissions;
authenticate the user data, wherein authenticating the user data comprises validating the user data associated with the NFC signals; and
authorize the interaction, wherein authorizing the interaction comprises comparing the user data with the access control policies to determine an access level associated with the user device.

3. The system of claim 1, wherein executing the instructions further causes the processing device to:
receive the NFC signals emitted from the NFC device;
generate a user prompt, wherein the user prompt requests the user to enter a user input via the user device;
receive the user input, wherein the user input comprises a personal identification number (PIN) associated with the user; and
validate the user input using the authorization hub.

4. The system of claim 1, wherein the interaction further comprises a resource transaction, and wherein the resource transaction exceeds a threshold value.

5. The system of claim 1, wherein encrypting the user data using the token further comprises:
requesting, via the application, the token from the authorization hub;
generating, via the authorization hub, the token, wherein the token may be configured to encrypt the user data;
transmitting the token from the authorization hub to the application; and
encrypting the user data using the token generated by the authorization hub.

6. The system of claim 1, wherein storing the user device as the verified user device further comprises bypassing verification of future interactions associated with the user device.

7. The system of claim 1, wherein validating the user data further comprises determining the user data received from the resource container matches a user database, wherein the user database includes information associated with the user.

8. The system of claim 1, wherein executing the instructions further causes the processing device to:
receive a new interaction from a new resource container, wherein the new resource container is associated with the user, and wherein the new interaction is received via NFC signals; and
validate the new resource container via the verified user device.

9. A computer program product for device authentication verification via electronic communication, the computer program product comprising a non-transitory computer-readable medium comprising code causing an apparatus to:
receive an interaction from a resource container, wherein the interaction is associated with an application;
transmit a token from an authorization hub to a user device;
receive user data from the resource container associated with a user, wherein the user data is received via a near field communication (NFC) device embedded in the resource container, and wherein the NFC device emits NFC signals;
encrypt the user data using the token;
validate the user data using the authorization hub; and
store the user device as a verified user device.

10. The computer program product of claim 9, wherein the authorization hub is configured to:
manage access control policies, wherein the access control policies define user access permissions;
authenticate the user data, wherein authenticating the user data comprises validating the user data associated with the NFC signals; and
authorize the interaction, wherein authorizing the interaction comprises comparing the user data with the access control policies to determine an access level associated with the user device.

11. The computer program product of claim 9, wherein the code further causes the apparatus to:
receive the NFC signals emitted from the NFC device;
generate a user prompt, wherein the user prompt requests the user to enter a user input via the user device;
receive the user input, wherein the user input comprises a personal identification number (PIN) associated with the user; and
validate the user input using the authorization hub.

12. The computer program product of claim 9, wherein the interaction further comprises a resource transaction, and wherein the resource transaction exceeds a threshold value.

13. The computer program product of claim 9, wherein encrypting the user data using the token further comprises:
requesting, via the application, the token from the authorization hub;
generating, via the authorization hub, the token, wherein the token may be configured to encrypt the user data;
transmitting the token from the authorization hub to the application; and
encrypting the user data using the token generated by the authorization hub.

14. The computer program product of claim 9, wherein storing the user device as the verified user device further comprises bypassing verification of future interactions associated with the user device.

15. The computer program product of claim 9, wherein validating the user data further comprises determining the user data received from the resource container matches a user database, wherein the user database includes information associated with the user.

16. The computer program product of claim 9, wherein the code further causes the apparatus to:
receive a new interaction from a new resource container, wherein the new resource container is associated with the user, and wherein the new interaction is received via NFC signals; and
validate the new resource container via the verified user device.

17. A method for device authentication verification via electronic communication, the method comprising:
receive an interaction from a resource container, wherein the interaction is associated with an application;
transmit a token from an authorization hub to a user device;
receive user data from the resource container associated with a user, wherein the user data is received via a near field communication (NFC) device embedded in the resource container, and wherein the NFC device emits NFC signals;
encrypt the user data using the token;
validate the user data using the authorization hub; and
store the user device as a verified user device.

18. The method of claim 17, wherein the authorization hub is configured to:
manage access control policies, wherein the access control policies define user access permissions;
authenticate the user data, wherein authenticating the user data comprises validating the user data associated with the NFC signals; and
authorize the interaction, wherein authorizing the interaction comprises comparing the user data with the access control policies to determine an access level associated with the user device.

19. The method of claim 17, wherein the method further comprises:
receive the NFC signals emitted from the NFC device;
generate a user prompt, wherein the user prompt requests the user to enter a user input via the user device;
receive the user input, wherein the user input comprises a personal identification number (PIN) associated with the user; and
validate the user input using the authorization hub.

20. The method of claim 17, wherein encrypting the user data using the token further comprises:
requesting, via the application, the token from the authorization hub;
generating, via the authorization hub, the token, wherein the token may be configured to encrypt the user data;
transmitting the token from the authorization hub to the application; and
encrypting the user data using the token generated by the authorization hub.
